(19) United States
(12) Patent Application Publication
(10) Pub. No.: US 2004/0194134 A1
(43) Pub. Date: Sep. 30, 2004

(54) Method and system for rapid channel change providing stored images of current channel programs

(76) Inventors: Priyan Deveka Gunatilake, San Diego, CA (US); Takaaki Ota, San Diego, CA (US); Christopher J. Read, San Diego, CA (US)

Correspondence Address: WAGNER, MURABITO & HAO LLP, Two North Market Street, Third Floor, San Jose, CA, 95113, US

(21) Appl. No.: 10/397,746

(22) Filed: Mar. 25, 2003

(51) Int. Cl. H04N 5/445; G06F 3/00; H04N 7/173; G06F 13/00

(52) U.S. Cl. 725/38; 725/54; 725/90

(57) ABSTRACT

Disclosed is a method for changing channels in a digital television transport stream, which comprises accessing the digital television transport stream, itself comprising a plurality of multiplexed channels, by using a first tuner, displaying a first program channel from the digital television transport stream, detecting and storing in a buffer memory recent video data from a second channel while displaying the first channel by using a second tuner, immediately recalling and presenting a complete video frame from the stored video data of the second channel for display when the second channel is selected by the user, and displaying real-time video from the second channel when decodable real-time video data is available from the transport stream.

### FIELD OF THE INVENTION

Embodiments of the present invention relate to the field of digital television devices.

### BACKGROUND OF THE INVENTION

Digital television has begun to deliver a variety of information and entertainment to viewers. An immense amount of very high quality digital video is available via broadcast, cable, and direct satellite communication.

A feature of digital television broadcast and cable delivery is the necessity of compressing a high-quality video image into a narrow band-width for storage and transport as an encoded and multiplexed signal. Compression and multiplexing allow for a single transport stream, carrying many channels, or programs, of digital television programming, to fit in the limited RF bandwidth of a legally defined frequency in the public airwaves or into the bandwidth necessary to efficiently use a cable carrying many different digital transport streams.

The common television formats used throughout the world involve presenting a sequence of picture frames in a display. Each of the frames, when compressed, must still be able to recover all the visual information that is necessary to show the full, decompressed, frame when presented in the ultimate display. The digital television standards in use allow for multiple compressed video programs with compressed audio as well as data channels.

It is noted here that the use of MPEG in this discussion refers to the various compatible compression standards of the Moving Pictures Experts Group which has promulgated several standards relating to compressed digital data delivery systems. One standard, known as MPEG-1, refers to ISO/IEC standards 11172 and is incorporated herein by reference as background. A second standard, known as MPEG-2, refers to ISO/IEC standards 13818 and is incorporated herein by reference as background. The delivery of coded video is commonly accomplished under ATSC (Advanced Television Standards Committee). A compressed digital video system is described in the ATSC digital television standard document A/53, also incorporated herein by reference as background.

A common video compression, or encoding, method is MPEG-2 which employs three different types of frames. The Intra-frame, or I-frame, incorporates all the information necessary to be decoded by itself. The other types of frames have to depend on an I-frame at some point. An I-frame provides the least amount of compression when encoded. The predictive frame, or P-frame, uses motion-adjusted differences from a previous reference frame to avoid redundant coding. The P-frame allows a greater amount of compression than the I-frame. The bi-directional frame, or B-frame, uses motion adjusted differences from both a previous and a future frame. The B-frame allows the greatest amount of compression when encoded.

It is noted that referencing incomplete frames to complete frames for decoding and decompression is not limited to MPEG compression schemes. Other encoding and compression techniques also use such referencing.

The three types of frames may all be incorporated when a program is encoded under MPEG. Typically, all three types of frames are incorporated. When more than one program is multiplexed into a single transport stream, the coded packets that contain the transported fragments of the encoded frames, in most coding conventions, are sequenced with each other. A demultiplexer at a receiving device can separate out the programs and, when a particular program is desired, decode the program for presentation in a display.

Conventional art FIGS. 1A and 1B illustrate an exemplary system that transports, receives and presents digital television from either broadcast or digital cable. It is noted that the illustrated system is only representative of digital television reception and does not show the workings of any specific device or system. Transport stream 101, containing the information necessary to present more than one channel of television, including audio and data, is demultiplexed at 102. A channel desired by the user, is selected at 103. Because decoding, 105, presents a frame at a time to the display, the continuing stream of data packets that make up the demultiplexed transport stream are buffered in a memory device as illustrated at 104. It is noted here that the memory buffer illustrated here may be located in a logical position differently than that shown. Presentation to display 106 takes place when decoder 105 has decoded a presentable frame. Information not desired for display, 107, is typically discarded, as illustrated by “bit bucket” 108.

One type of consumer device in use in the analog as well as the digital television arenas is the Picture-in-Picture, or PIP. A PIP allows the presentation of a small video window, within the larger main video presentation, which shows a different program than that shown in the main presentation. By presenting a view of an alternate program, PIP offers a way of rapidly assessing whether the alternate channel is one the viewer wishes to view; e.g., it provides a fast channel surfing mode.

The ability to quickly change channels in a television is a feature that television viewers enjoy. “Channel Surfing” has come to describe the quick switching between channels. This has only been possible with analog television when demanded across the spectrum of available channels.

There are two main sources of delay in a digital television system which make quick channel surfing difficult. One is inherent in the tuning/demodulation of a digital transport stream. When a new frequency is selected, there is a time lag before the digital bitstream emerges from the demodulator.

The other delay source is in data delay. When a new bitstream arrives, the television waits until it determines which parts of the signal to use, and until it receives an I-Frame, before presenting a video image to the viewer.

In tuning/demodulation, while actual tuning may not take longer, the previously unneeded digital demodulation can take some time to lock onto the transport stream, then once demodulated, the stream may have to be parsed for information as to what the signal contains. Once the information is known, the television waits for an I-frame before it can begin to decode real-time video. Since I-frames can be as much as a second apart in any channel, the total delay between one channel and another can be quite long; e.g., on the order of several seconds.

Previous fast channel change methods have concentrated on delivering a new “live” picture as quickly as possible. However, all the previous methods have a limited range of channels to which they can change rapidly.

In conventional art FIG. 1B, the coded frames component of a transport stream is shown to illustrate causes of digital channel change delay. A typical transport stream, such as shown at 120, contains, among other channels of information, channels of data packets which encode the frames of video sources. As noted above, multiple channels are encoded and multiplexed in a single digital transport stream. The time-equivalent frame sequence of more than one encoded and multiplexed channel is what is illustrated in FIG. 1B. Exemplary I-frame 121 is shown as an I-frame from one channel, channel A, as an example. Exemplary P-frame 122 is shown as a P-frame of channel A and exemplary P-frame 123 is shown as a B-frame of channel B. Exemplary I-frame 124 is an I-frame of channel B and P-frames 125 and 126 are exemplary P-frames of channels A and C, respectively. The other exemplary frames are P- and B-frames of other channels.

It is noted here that video information is not coded into a transport stream as frames but as coded data packets which represent the frames and that packets containing data from frames of different programs may be interleaved together. The data packets contain the information from which frames are constructed upon decoding. The illustrations of FIGS. 1A and 1B are shown to illuminate the background of digital television transmission.

It is also noted that the exemplary frames are shown in different sizes in FIG. 1B. P-frames are shown larger than B-frames and I-frames are shown as the largest. The difference in size is only for the sake of illustration of the relative compression ratios of the frames. An I-frame offers the least compression and a B-frame offers the most.

It is further noted that there is not a specific order to frames or to channels when multiplexed. The adaptive compression rate of MPEG-2 means that different parts of different programs compress more or fewer frames into a given amount of available bandwidth, depending on the instant video content. For this reason, there can be as much as several seconds between receiving of sequential I-frames of any particular channel. Because of the possible wait time for a first received I-frame after a channel switch by a user, a channel change causes a temporary delay before the new channel image can be displayed. Alternatively, some displays may present artifacts or other unwanted images as a result of incomplete decoding of the channel switch because, in a single program video bit stream, an I-frame is inserted among groups of P- and B-frames. In a multiplexed transport stream, there may four to six, or more, programs multiplexed together. Importantly, the next I-frame after a switch to a desired channel could lag two or more seconds behind the channel switch.

Television viewers perceive seamless, rapid, switching from one channel to another to be an important television receiver characteristic. The necessity of referencing an I-frame when decoding digital television can make channel switching time long when compared to the switching times of traditional or analog television receivers. Thus, in some cases the viewer can be presented with a blank or otherwise non-program screen for several seconds when switching channels in a digital television, giving the viewer no information about whether the new channel is one he or she cares to view.

### SUMMARY OF THE INVENTION

Accordingly, a novel method and system for accommodating rapid digital television channel surfing in a is presented here. Embodiments of the present invention involve immediately presenting a still image upon each channel change that is representative of the current programming in the selected channel. These still images are decoded from stored, most recent, I-frames of the respective channels and the subsequent subordinate frames.

More specifically, disclosed is a method for changing channels in a digital television transport stream, which comprises accessing the digital television transport stream, itself comprising a plurality of multiplexed channels, by using a first tuner, displaying a first program channel from the digital television transport stream, detecting and storing in a buffer memory recent video data from a second channel while displaying the first channel by using a second tuner, immediately recalling and presenting a complete video frame from the stored video data of the second channel for display when the second channel is selected by the user, and displaying real-time video from the second channel when decodable real-time video data is available from the transport stream.

Embodiments of the present invention also make use of the “unused” tuner/demodulators in the digital television receiver system for updating the stored data across each channel. In these embodiments, each “unused.” tuner/demodulator is used to scan through all the available channels in the frequency spectrum. At each program channel, the transport stream is accessed long enough to receive an entire full-frame video still image, requiring at least one I-Frame, from each program within the transport stream. The received compressed I-Frame is stored in a memory space associated with the respective channel, and the tuner/demodulator moves on to the next frequency or channel to construct an array of still images of all channels. This array of still images can be quickly displayed as a user “surfs” through channels. The images the user sees are not “live,” or real-time, but are as recent as the unused tuner accessed that frequency. When user selection rests on a channel long enough, the system is able to decode real-time video data and the program channel becomes live as soon as sufficient data is received to present full-frame presentation, e.g., usually within one or two seconds. In this fashion, a channel surfing user can quickly assess whether or not the present channel is desired for further watching without having to wait for a full-frame presentation to be decoded from that channel in real time.

These and other objects and advantages of the present invention will become obvious to those of ordinary skill in the art after having read the following detailed description of the preferred embodiments which are illustrated in the various drawing figures.

### BRIEF DESCRIPTION OF THE DRAWINGS

The operation and components of this invention can be best visualized by reference to the drawings.

FIG. 1A (Conventional art) illustrates an exemplary digital television receiver.

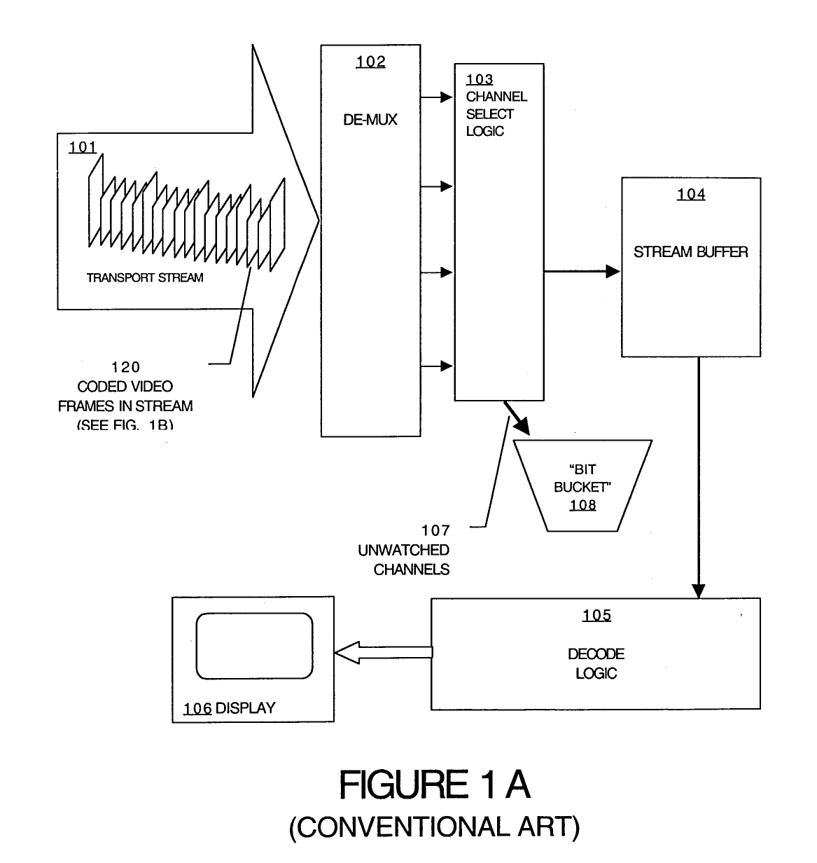

FIG. 1B (Conventional Art) illustrates an exemplary sequence of encoded multiple channel frames in a digital television transport stream.

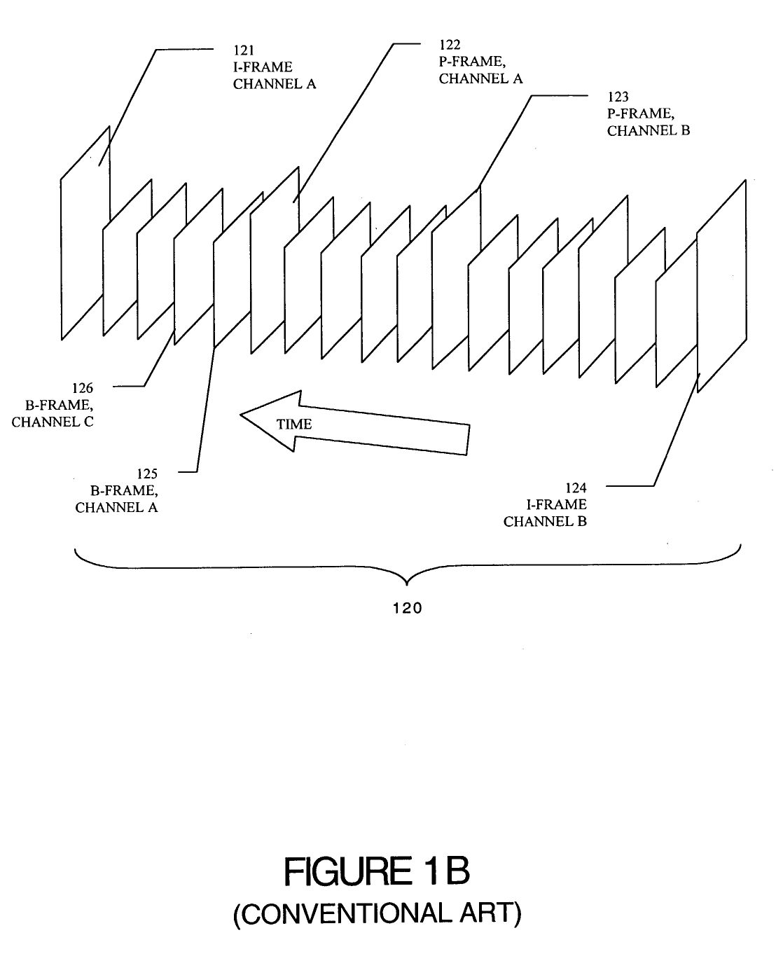

FIG. 2 illustrates a method for rapid channel change within a transport stream in accordance with an embodiment of the present invention.

FIG. 3 illustrates a system for rapid channel change in a transport stream in accordance with an embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it should be understood by one of ordinary skill in the art that the present invention may be practiced without these specific details. In other instances, well-known methods, procedures, components, and circuits have not been described in detail so as not to unnecessarily obscure aspects of the present invention. At times, concepts disclosed in this discussion of embodiments of the present invention will be made more readily apparent by reference to the Figures.

This application incorporates herein by reference the co-pending patent applications, attorney docket number 50R4613, entitled “METHOD AND APPARATUS FOR SWITCHING TELEVISION CHANNELS,” and attorney docket number 50R4614, entitled “METHOD AND SYSTEM FOR RAPID CHANNEL CHANGE WITHIN A TRANSPORT STREAM,” both filed concurrently herewith and assigned to the assignee of the present application.

Embodiments of the present invention provide for “channel surfing,” rapid switching from channel to channel, in a digital television environment. “Channel surfing” implies that the user is visually scanning the presented programming for whichever program channel he or she desires to view. Embodiments may make use of an “unused” tuner/demodulators, or demux/decoder, in a system such as found in a Picture-in-Picture television receiver, but use them in a very different manner.

In a picture-in-picture (PiP) television system the second tuner/demodulator or demux/decoder receives a second program channel and presents it in a window in the primary presentation display. If the PiP window is not being displayed then the PiP tuner is not being used. In embodiments of this invention, each “unused” tuner/demodulator is used to periodically scan through all the available program channels in a digital transport stream. At each channel, the transport stream of that channel is accessed long enough to receive an entire video frame still image, e.g., requiring at least one I-Frame, from each program channel within the transport stream. The received and compressed full-frame video still image is saved in a respective buffer memory space for that channel and the tuner/demodulator moves on to another channel, thereby constructing an array of still images that are periodically updated. The array of still images can be quickly displayed as a user “surfs” through channels. The images the user sees during surfing are not “live,” e.g., they are not real-time video, but they are as recent as when the unused tuner last accessed that frequency to update the array of still images. However, when the user rests on a program channel for long enough, the transmitted video data is received and decoded by the system and real-time video is displayed as soon as available, usually within one to two seconds. The embodiment is helpful and advantageous because the still image displayed during surfing is much more desirable than a black screen or a screen filled with artifacts that are not recognizable. Eventually, the real-time received video catches up with the selected channel and the program is displayed real-time.

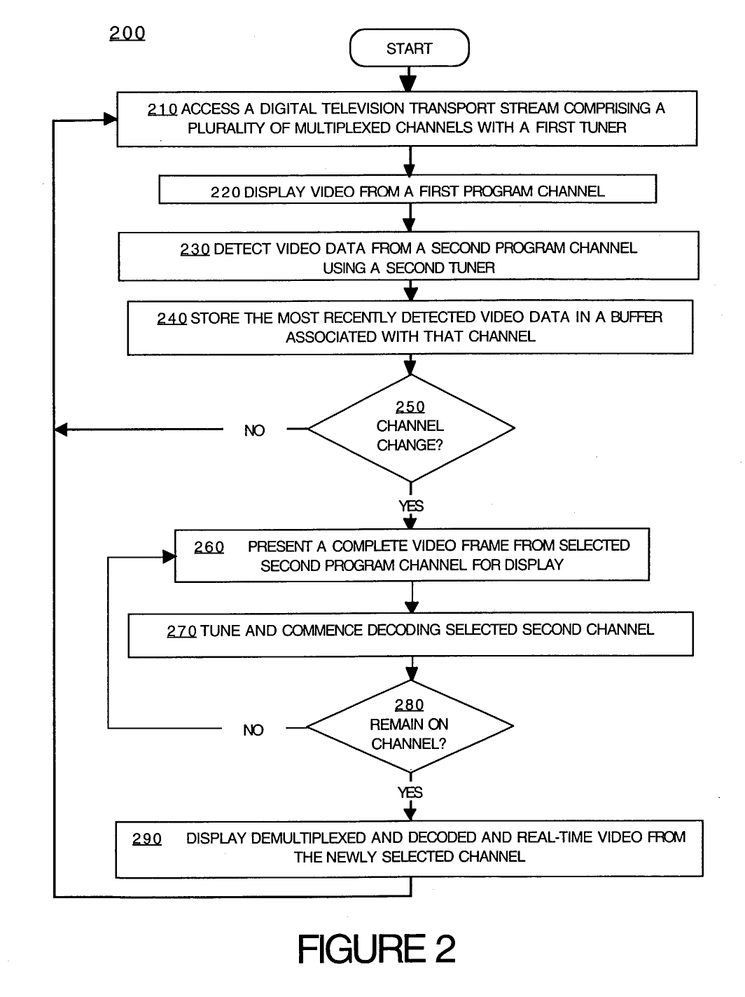

FIG. 2 illustrates a flow diagram of a method for “channel caching” in accordance with embodiments of the present invention. It is noted that “channel caching” refers to the method outlined above, wherein a video frame (or more) is captured from a program channel and stored, or cached, while another program channel is being viewed. Method 200 starts by accessing a signal carrying a digital transport stream, step 210, which contains a plurality of multiplexed program channels. The accessing is accomplished with a first tuner. Real-time video is displayed from one of the available program channels at step 220 due to a user selection thereof. While real-time video is being displayed from the selected channel, video data is detected from a second video channel at step 230. The video data detected for the second channel can be accomplished using a second tuner, apart from the tuner used at step 220. At step 240 a full video frame still image from the most recently detected video data of a program channel is stored in a buffer associated with that program channel, e.g., the second video channel. It is noted that there can be a multiplicity of stored frames in a multiplicity of buffers in various embodiments. Each time step 230 is entered, the second video channel tuner selects a new program, either within the current transport stream or by tuning to a new frequency, and a new buffer location is updated thereby constructing an array of still images in the buffer memory.

If the user selects a different channel from that being viewed, step 250, the stored video frame corresponding to the different channel is immediately presented to the display, step 260, while the real-time video data from the new channel is accessed and decoded at 270. If the user views the newly selected channel for a sufficient amount of time, step 280, the display of real-time video is automatically commenced at step 290. If the user does not remain on the selected channel, then a stored frame still image is again displayed for whichever channel is next selected by the user, step 260. In one embodiment, the sufficient amount of time of step 270 is about one to three seconds, which signals exiting surfing and selection of a new channel for viewing real-time broadcast. At that point, the newly selected channel corresponds to the first channel of step 220.

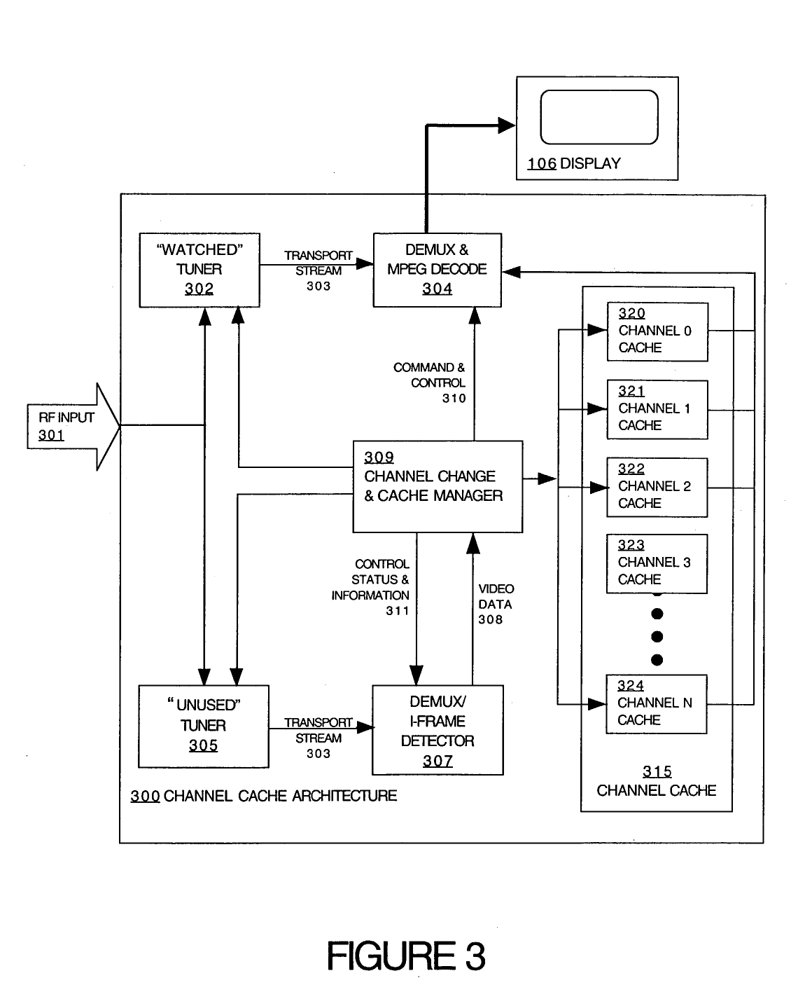

FIG. 3 illustrates, in block diagram form, a receiver system in accordance to an embodiment of the present invention. There, channel cache architecture 300 is characterized by receiving a television signal, 301, containing encoded, multiplexed, digital television programming. It is noted here that a received signal containing digital television programming may be a broadcast radio frequency (RF) signal, a cable signal, or any other signal arriving from anywhere other than internally to the receiver involved in this embodiment of the present invention. The input signal is received by a tuner 302 if RF or otherwise appropriately accessed and digital transport stream 303 is separated out. The desired program channel is demultiplexed and decoded at 304 and sent to display 106. In this embodiment, a second tuner, 305, also separates out a digital transport stream 303. It is noted here that, in some embodiments of the present invention, the functions of tuners 302 and 305 can be switched, do that either tuner may be the “watched” tuner and the other may be the “unused” tuner. In other embodiments, there can be more tuners which can also be either “watched” or “unused” tuners.

An additional demultiplexer/decoder periodically scans through the transport stream for video data in each program channel at 307 and video data 308 is sent to a channel change and cache manager 309. With sufficient recent data to form a full video frame still image from a given channel, the cache manager stores the most recently obtained full video frame still image in the channel cache 315, in a buffer space associated with the given channel, shown here as channel 0 cache, 320, through channel N cache, 324, to accommodate N+1 channels. In this embodiment, the available program channels are continually scanned in this manner by tuner 305 and the obtained frames stored in the respective channel caches are continually updated so that a very recent full video frame still image is always stored in the cache. In one embodiment, at least a full I-Frame is stored in the corresponding cache location, 0−N, for each channel. In other embodiments, several brief frames may be stored in addition to the I-Frame. The recent video frame still image is then always available to be immediately sent from the cache to demultiplexer/MPEG decoder 304 to be displayed in display 106 whenever the associated channel, channel i, is selected by the user during channel surfing.

At the same time the new full video frame still image is obtained from cache i and sent to the display, channel change and cache manager 309, via command and control 310, instructs MPEG decoder 304 to begin decoding real-time video for the newly selected program channel i in transport stream 303. If the user remains tuned to the newly selected channel i, real-time video is then displayed immediately as soon as full-frame, real-time video is available. Using this method, the user can immediately see, by viewing the full video frame still image (which is characteristic of the current programming), whether the newly selected program channel is one he or she may want to view without having to wait for real-time video decoding to commence, which can take several seconds to occur. Moreover, the still image obtained from the cache 315 may function adequately for surfing purposes where a decision to view or not may be made from the stored still image.

In one embodiment, the second tuner 305 may be the picture-in-picture tuner used in many television systems. When not used for picture-in-picture, purposes, this tuner can be used to periodically update the array of still images corresponding to channel 0 and to channel N of cache 315.

Embodiments of the present invention enable the ability to quickly change channels in a television which is a feature that users have grown used to. Channel surfing has come to describe the quick switching between channels and quick visual scanning of the programs presented. Though previously only possible with analog television, embodiments of the present invention overcome the limitations to channel surfing found in conventional digital television. Some of these limitations have been addressed in referenced co-pending applications cited previously.

The two primary sources of delay overcome by embodiments of the present invention are, (1) tuning/demodulation delay which is the time lag between when a new frequency is selected and when the digital bitstream emerges from the demodulator; and (2) data delay which is the time lag associated with decoding the digital bit stream. When a newly selected bit stream arrives at the decoder, the system waits until it detects which parts of the signal to use, and until it receives an I-Frame. The total delay can be on the order of one to two seconds.

While previous fast channel change concepts have concentrated on delivering a new live picture as quickly as possible, all the previous methods have a limited range of channels that they can change to fast. Embodiments of the present invention make use of extra tuner/demodulators in a system to scan through all available channels. At each frequency, the transport stream is received long enough to receive an entire frame, or I-Frame from each program within the transport stream. The received compressed full frame video still image I-Frame is stored, and the tuner/demodulator moves on to the next frequency to build an array of still images. The array of images can be quickly displayed as a user “surfs” through channels. The images he sees are not “live,” but are as recent as the unused tuner accessed that frequency. When the user rests on a new channel for more than a necessary period of time, it is tuned by the system and delivers real-time video programming after one to two seconds. At the completion of the prescribed period, the first tuner 302 then continues to decode the new channel in real-time.

Another embodiment of the present invention takes advantage of a system in which there are three or more tuners in the system. While a first tuner is used to display the channel being viewed and a second tuner is being used to scan other channels for storable video still images as described above. A third, and more if available, can be used for tuning to channels that a predictive capability of the system guesses will be accessed next by the user and tunes the predicted program channel before the user switches to it. In this fashion, the predicted channel is already being decoded prior to the user's channel selection and minimal time lag is encountered during the channel switch.

Yet another embodiment of the present invention enables entering a channel explicitly on a remote control keypad and directing a spare tuner to decode the desired next channel as described above. It is noted that this jump to a new channel does not allow good prediction of channels. The cached still frame will allow a relevant picture to be displayed until the tuner/demodulator/demux/decode capability can catch up.

Other embodiments of the present invention are able to demultiplex and decode channels in the incoming transport stream by other methods not discussed in detail here. However, when changing channels within a transport stream, the various embodiments of the present invention are able to immediately commence presentation of the selected channel's programming by presenting a stored full frame video still image I-frame from which P-frame and B-frame decoding can commence. In this way, the delays in presentation brought on by a channel change are reduced if not eliminated.

Still other embodiments of the present invention are able to demultiplex and decode channels in an incoming transport stream that comprises I-slices. An I-slice contains information necessary to the decoding of other slices of the video stream of a transmitted channel and the behavior of these embodiments is much like that of those embodiments which decode and store an I-frame for decoding reference by subordinate frames. In this embodiment, a grouping of I-slices is decoded and stored sufficient to provide an entire still image frame for each program in the transport stream, before moving on to the next frequency or on to the next transport stream. The tuner, in this embodiment, remains on the selected program channel for a sufficient time to receive a set of I-slices sufficient for the still image. As in the previously described embodiments, this embodiment provides an immediate and seamless channel change when selecting another channel within the present transport stream.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

We claim:

1. A method for changing channels in a digital television transport stream, comprising:
accessing said digital television transport stream comprising a plurality of multiplexed channels by use of a first tuner;
displaying current video programming from a first program channel from said digital television transport stream;
detecting and storing recent video data from a second program channel from said transport stream, by use of a second tuner, in a buffer memory while displaying said first channel;
recalling from said buffer memory and presenting a complete still video image of said second channel for display when said second channel is selected by a user; and
displaying current video programming from said second channel when decodable current video data becomes available from said transport stream.

2. The method for changing channels described in claim 1, wherein said complete video frame recalled from said buffer memory comprises an I-frame.

3. The method for changing channels described in claim 1, wherein said recent video data stored in said buffer memory for said second channel comprises a frame comprising an I-slice.

4. The method for changing channels described in claim 1, wherein said recent video data stored in said buffer memory for said second channel comprises a plurality of frames comprising one or more I-slices

5. The method for changing channels described in claim 1, wherein said accessing said digital television transport stream comprises demultiplexing said plurality of multiplexed channels.

6. The method for changing channels described in claim 1, wherein said displaying current video programming from said first program channel comprises demultiplexing said plurality of multiplexed channels.

7. The method for changing channels described in claim 1, wherein said storing recent video data comprises periodically storing the most recent I-frame of said second channel.

8. The method for changing channels described in claim 7, wherein said storing the most recent I-frame comprises periodically storing the most recent encoded bit stream of each of said plurality of multiplexed channels in said transport stream in respective buffers.

9. The method for changing channels described in claim 7, wherein said storing the most recent I-frame comprises periodically storing the most recent I-frame of each of said demultiplexed channels from said transport stream in respective buffers.

10. The method for changing channels described in claim 1, wherein said second tuner is a picture-in-picture tuner.

11. A display system for channel change of channels of a digital transport stream, comprising:
a demultiplexing device for separating a digital television channel from said digital transport stream comprising a plurality of multiplexed channels;
a memory device coupled to said demultiplexing device for storing a recent frame of said digital television channel;
a channel selecting device for selecting said digital television channel from among said plurality of multiplexed channels; and
a decoding device coupled to said memory device and to said demultiplexing device for decoding said digital television channel for presentation in a display, wherein said stored frame is first supplied to said decoding device for still image display in response to a channel change to said digital television channel followed by digital data from said demultiplexing device.

12. The system described in claim 11, further comprising an I-frame detector coupled to said memory device.

13. The system described in claim 11, wherein said recent frame is an I-frame.

14. The system described in claim 13, wherein said decoding device decodes subordinate frames of said digital television channel in reference to said stored I-frame to display said still image display.

15. The system described in claim 11, wherein said memory device stores a transport stream bit sequence comprising said plurality of multiplexed channels.

16. The system described in claim 11, wherein said memory device comprises a plurality of memory buffer spaces for storing a respective recent frame from each of said plurality of multiplexed channels.

17. The system described in claim 16, wherein said respective recent frames are I-frames.

18. A digital television receiver comprising:
a demultiplexer for separating a digital transport stream into a plurality of individual digital channels;
a plurality of buffers, each buffer for storing a recent frame associated with an individual digital channel;
a decoder for decoding digital data associated with a channel for display on a display screen; and
logic, responsive to a channel change, for supplying said decoder with a stored frame from a buffer associated with a selected channel for still image display, said logic then supplying said decoder with digital data associated with said selected channel from said demultiplexer.

19. A digital receiver as described in claim 18 wherein each buffer in said plurality of buffers stores an I-frame associated with an individual digital channel and further comprising an I-frame detector coupled to said demultiplexer for detecting I-frames in said plurality of individual digital channels.

20. A digital receiver as described in claim 19 wherein each buffer stores a plurality of recent frames associated with an individual digital channel and wherein one of said plurality of recent frames is an I-frame.

21. A digital receiver as described in claim 18 wherein said decoder is an MPEG (Motion Pictures Expert Group) compatible digital decoder.

22. A digital receiver as described in claim 18 wherein said buffers are implemented as individual address spaces of a single memory device.

23. A method of decoding information for display on a display screen comprising:
a) tuning a plurality of digital channel signals in a digital transport stream;
b) periodically storing a recent frame associated with each individual digital channel signal of said plurality of individual digital channel signals;
c) generating a signal representing a first digital channel for supply to said display screen by decoding a digital channel signal associated with a first digital channel;
d) responsive to a channel change from said first digital channel to a second digital channel, performing the following:
d1) recalling a stored recent frame associated with said second digital channel;
d2) displaying a still image representing said stored recent frame while awaiting a decodable digital video signal associated with said second digital channel; and
d3) generating a signal representing said second digital channel for supply to said display screen by decoding said video signal associated with said second digital channel in reference to said stored recent frame of said d1).

24. A method as described in claim 23 wherein said recent frame associated with each individual digital channel signal is an I-frame and further comprising, in response to said a), detecting I-frames within said plurality of individual digital channel signals.

25. A method as described in claim 23 wherein said stored recent frame associated with said second digital channel is stored before said channel change.

26. A method as described in claim 23 wherein said b) is performed using a plurality of individual buffer memories, each buffer memory for storing a respective recent frame.

27. A method as described in claim 23 wherein said c) is performed using a first tuner.

28. A method as described in claim 23 wherein said d) is performed using a second tuner.
